(19) United States
(12) Patent Application Publication
(10) Pub. No.: US 2011/0109421 A1
(43) Pub. Date: May 12, 2011

(54) SWITCH MODULE

(75) Inventors: YU-LUNG LEE, MIAOLI COUNTY (TW); JUNG-HUI HSU, TAIPEI COUNTY (TW)

(73) Assignee: POWERTECH INDUSTRIAL CO., LTD., TAIPEI HSIEN (TW)

(21) Appl. No.: 12/757,387

(22) Filed: Apr. 9, 2010

(30) Foreign Application Priority Data
Nov. 6, 2009 (TW) 98137721

(51) Int. Cl. H02B 1/04

(52) U.S. Cl. 337/112; 361/673; 337/34

(57) ABSTRACT

A switch module having a surge absorber is disclosed. In one embodiment according, the switch module includes a casing having an input terminal, an output terminal and an auxiliary terminal, a switch unit installed in the casing for connecting or disconnecting the input terminal to the output terminal, and a surge absorber installed in the casing and between the output terminal and the auxiliary terminal. Therefore, the switch module is capable of absorbing a voltage spike from the input terminal and thus shielding the circuitry of the switch module from damage.

### BACKGROUND OF THE INVENTION

1. Field of the Invention

The present invention relates to a switch module. In particular, the present invention relates to switch module having a surge absorber.

2. Description of Related Art

A conventional switch module is shown in the FIG. 1. The conventional switch module 1 includes a press portion 11, a touching block 13, a conductive leverage 15, a first junction plate 171, a second junction plate 173 and a third junction plate 175. The touching block 13 is configured to push the conductive leverage 15 so that the first junction plate 171 could be in connection with or to be disconnected from the second junction plate 173. As such, a power could be switched on or off according to whether the press portion 11 is pressed. Meanwhile, the third junction plate 175 is connected with a lighting device for indicating.

The power surge and the voltage surge take place from time to time, and as the result the switch module 1 may be burned since the temperature associated with the switch module 1 may increase when the switch model 1 lacks the function of surge absorbing.

Another conventional switch module has an overload protection mechanism in which the conductive leverage 15 is added. The conductive leverage 15 is configured to be lifted up automatically when a predetermined value of a current has been reached.

Abovementioned switch is often integrated with a power strip for controlling an output of the power strip. The power strip with the switch module is generally a receiving end of a voltage spike that may cause damage to an electronic device connected with the power strip. Consequently, the power strip and the switch module are equipped with a surge protection module for limiting the surge in order to minimize the damage caused.

Additionally, traditional surge absorbers generally are in a parallel connection with the switch. However, that the surge absorber may have to be installed on a printed circuit board defeats the purpose of minimizing the size of the electronic equipment.

### SUMMARY OF THE INVENTION

One objective of the present invention is to minimize space and cost of the switch and the surge absorber.

The switch module includes a casing having an input terminal, an output terminal and an auxiliary terminal, and a switch unit installed in the casing for connecting or the input terminal to the output terminal or disconnecting the former from the latter. The switch module according to the present invention further includes a surge absorber installed in the casing and between the output terminal and the auxiliary terminal for absorbing a voltage spike from the input terminal.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a schematic diagram of a conventional switch module,

FIGS. 2A, 2B, 2C, 2D and 2E are schematic diagrams of the switch module in accordance with one embodiment of the present invention.

FIG. 3 is a schematic diagram of the switch module in accordance with one embodiment of the present invention.

FIGS. 4A, 4B, 4C and 4D are circuitry diagrams of the switch module in accordance with one embodiment of the present invention, and

FIGS. 5A, 5B, 5C, 5D and 5E are circuitry diagrams of the switch module in accordance with one embodiment of the present invention.

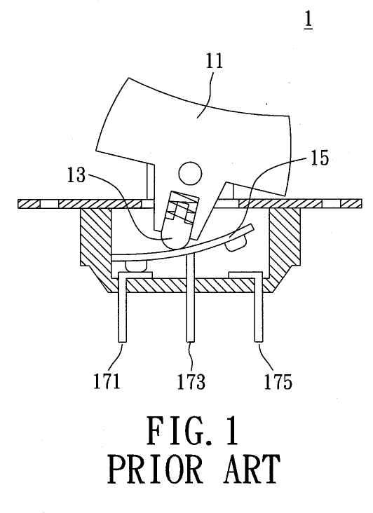

### DETAILED DESCRIPTION OF THE PREFERRED EMBODIMENTS

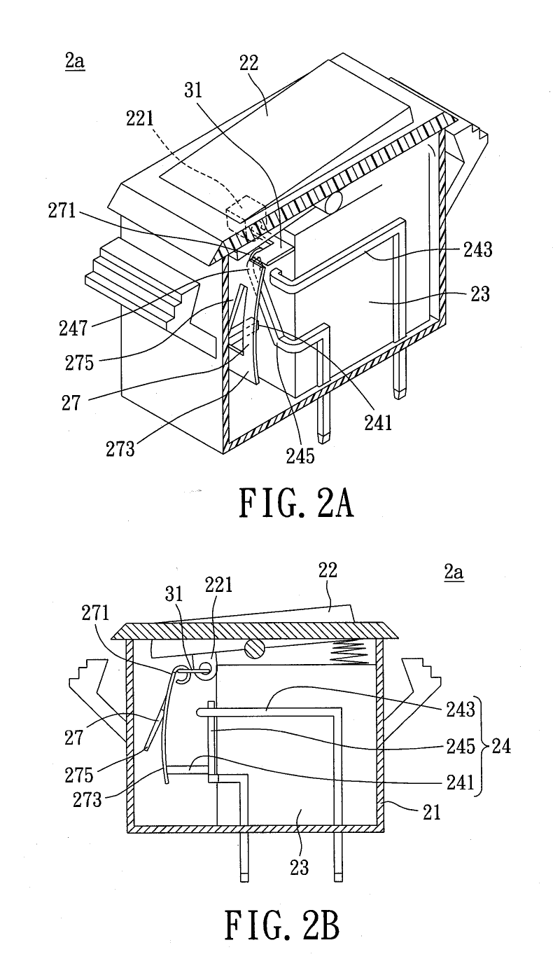

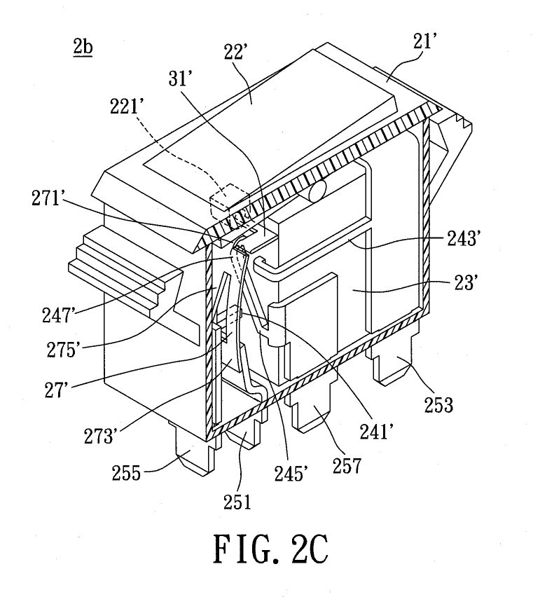

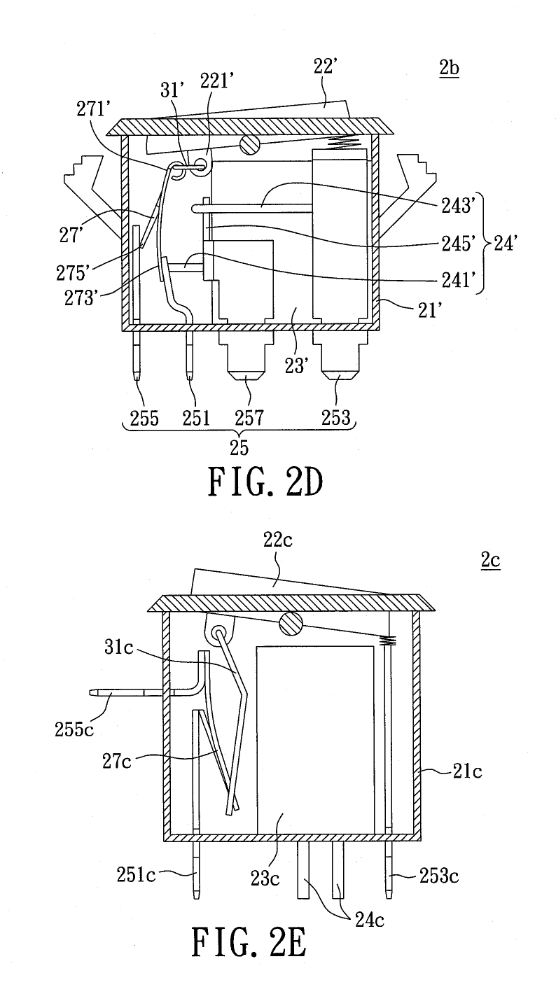

FIG. 2A and FIG. 2B are schematic diagrams of the switch module in accordance with one embodiment of the present invention.

Throughout the disclosure, the switch module 2a includes a casing 21, a surge absorber 23 and a switch unit 27. The casing 21 has a recess, and the surge absorber 23 is installed in the casing 21 and has at least two pins. In one embodiment, the absorber 23 has first pin 241, a second pin 243, a third pin 245 and a fourth pin 247. The surge absorber 23 is coupled with an electronic device controlled by the switch module 2a. The switch unit 27 is installed in the casing 21 and has a first free end 273 and a second free end 275. The first free end 273 is connected with the first pin 241 in a detachable fashion, and the second free end 275 is coupled with a power source (not shown). Thereby, when the switch module 2a is turned on and receives a voltage spike, the surge absorber 23 absorbs the voltage spike for protecting the electronic device.

The switch module 2a further includes a switch controller 22, a flange 221 and a shackle bar 31. The switch unit 27 further includes a connecting end 271. The switch controller 22 could be a press portion installed at one side of the casing 21 and protrudes beyond an external surface of the casing 21. The flange 221 is installed under the switch controller 22 and is connected with the connecting end 271. The first free end 273 of the switch unit 27 is connected to or disconnected from the first pin 241 according to the operation of the switch controller 22 so as to ensure the surge absorber 23 is electrically connected to or disconnected from the power source. In one embodiment, the switch controller 22 could be a bimetal strip or a thermal sensing plate that is configured to turn off the switch unit 27 while the overload occurs.

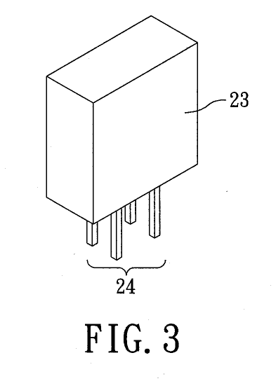

The surge absorber 23 could be a metal oxide varistor (MOV), a Zener diode or a gas discharge tube. In one implementation, the surge absorber 23 is a circular disk in shape. In another implementation, the surge absorber 23 is a long strap in shape. Moreover, the surge absorber 23 is shaped as a ring shown in FIG. 3, which is a schematic diagram illustrating a switch module according to one embodiment of the present invention. The material of the surge absorber 23 could be metal oxide such as zinc oxide or strontium oxide. In one embodiment, the surge absorber 23 includes a surge absorption device (no shown) having at least two pins. The surge absorber 23 may have a first pin 241, a second pin 243 and a third pin 245. The first pin 241 is coupled with power source via the switch unit 27, the second pin 243 is coupled with an auxiliary terminal (not shown), and the third pin 245 is coupled with a ground terminal. Thereby, the surge absorber 23 absorbs a voltage spike for protecting the electronic device while the surge absorber 23 receives the voltage spike from the power source terminal or the auxiliary terminal.

FIG. 2C and FIG. 2D are schematic diagrams of the switch module in accordance with one embodiment of the present invention.

A switch module 2b includes a casing 21′, a surge absorber 23′ and a switch unit 27′. The casing 21′ has a recess associated with a plurality of junction plates 25, and the surge absorber 23′ is installed in the casing 21′ and has a plurality of pins 24′. The junction plates 25 includes a first junction plate 251, a second junction plate 253, a third junction plate 255 and a fourth junction plate 257. The pins 24′ includes a first pin 241′, a second pin 243′, a third pin 245′ and a fourth pin 247′. The plurality of the pins 24′ are connected with the plurality of junction plates 25, respectively. The surge absorber 23′ is coupled with an electronic device (not shown). The switch unit 27′ has a first free end 273′ and a second free end 275′.

The third junction plate 255 is configured to serve as an input terminal of the switch module 2b and coupled with a power source (not shown). The second junction plate 253 is configured to serve as the auxiliary terminal of the switch module 2b and coupled with another power source of an opposite polarity (not shown). The fourth junction plate 257 is configured to serve as the ground terminal of the switch module 2b and coupled with ground end. The first free end 273′ is configured to serve as an output terminal of the switch module 2b and detachable with respect to the first junction plate 251 according to the manual operation of the switch on/off. The second free end 275′ is connected with the third junction plate 255, the first pin 241′ is connected with the first junction plate 251, the second pin 243′ is connected with the second junction plate 253, the fourth pin 247′ is connected with the third pin 245′, and the third pin 245′ is connected with the fourth junction plate 257. Thereby, the surge absorber 23′ could absorb a voltage spike for protecting the electronic device while the surge absorber 23 receives the voltage spike.

The switch module 2b further includes a switch controller 22′, a flange 221′ and a shackle bar 31′ and the switch unit 27′ further includes a connecting end 271′. The switch controller 22′ is installed at one side of the casing 21′ and protrudes beyond the external surface of the casing 21′. The flange 221 is installed under the switch controller 22′ and is connected with the connecting end 271′ via the shackle bar 31′ and the connecting end 271′. The first free end 273′ of the switch unit 27 is connected to or disconnected from the first junction plate 251 according to the operation of the switch controller 22′ so as to ensure the surge absorber 23′ is electrically connected to or detached from the power source.

FIG. 2E is a schematic diagram of the switch module in accordance with one embodiment of the present invention.

The switch module 2c includes the same devices with the switch module 2b in FIG. 2C. The difference is the relative position of pins 24c, junction plates 251c˜255c, a switch controller 22c, shackle bar 31c and a switch unit 27c in a casing 21c.

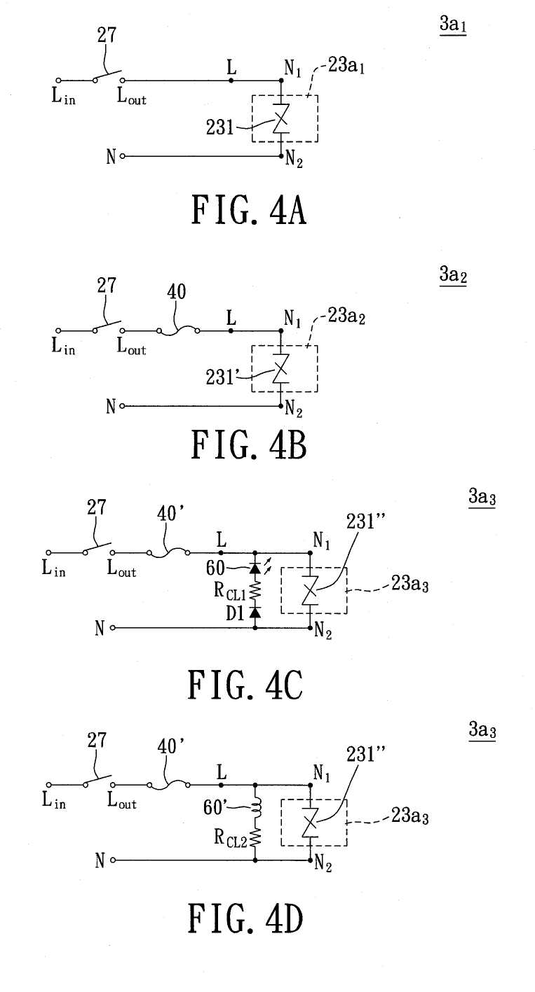

FIG. 4A is a circuitry diagram of the switch module in accordance with one embodiment of the present invention.

A switch 3a₁ includes a surge absorber 23a₁, an input terminal Lᵢₙ, an output terminal Lout, a power source terminal L, a switch unit 27, an auxiliary unit N, a first node N₁ and a second node N₂. The switch unit 27 controls the input terminal Lin to be connected with the output terminal Lout according to the operation of the switch controller 22. One end of the power source terminal L is connected with the first node N₁ and the other end of the power source terminal L is connected with the power source when the input terminal Lᵢₙ connects the output terminal Lₒᵤₜ. One end of the auxiliary terminal N is connected with another power source of an opposite polarity, and the other end of the auxiliary terminal N is connected with the second node N₂.

The surge absorber 23a1 includes a first surge absorption device 231 coupled to the first node N₁ and the second node N₂. In one implementation, an electronic device (not shown) may be in a parallel connection with the first surge absorption device 231, wherein the electronic device could be a power signal processor of the electronic equipment or a power signal processor of a power strip. The surge absorber 23a₁ receives the power source through the power source terminal L when the output terminal Lₒᵤₜ is connected with the input terminal Lᵢₙ. If the voltage at the first surge absorption device 231 is lower than a predetermined threshold, the first surge absorption device 231 is associated with “high” impedance. If the voltage on the first surge absorption device 231 exceeds the threshold voltage as the result of the voltage spike, the impedance associated with the first surge absorption device 231 is “low” so as to allow a large amount of current to pass through the first surge absorption device 231. The energy is absorbed by the surge absorption device 231 and dissipated in the form of heat emission so as to protect the electronic device. The surface of the first surge absorption device 231 could be configured to be larger so as to increase the heat dissipation efficiency.

FIG. 4B is a circuitry diagram of the switch module in accordance with one embodiment of the present invention.

A switch circuit 3a₂ is similar to the switch circuit 3a₁ while the switch module 3a₂ further includes a first thermal protection device 40 coupling the power source terminal L and the output terminal Lout. In one implementation, the first thermal protection device is a fuse. The first surge absorption device 231′ may absorb the voltage spike of short duration and the transient voltage spike. If the voltage spike lasts for too long time or the voltage spike absorbed by the first surge absorption device 231′ exceeds the threshold voltage, the absorbed voltage spike may be turned to excessive heat, increasing the likelihood that a peripheral device or the switch module 2a, 2b or 2c is destroyed. Therefore the first thermal protection device 40 is configured to be open circuited so as to stop the current from passing through when the first thermal protection device 40 reaches or exceeds a threshold temperature so as to protect the surge absorber 23a₂ and the peripheral device.

FIG. 4C and FIG. 4D are circuitry diagrams of the switch module in accordance with one embodiment of the present invention.

A switch circuit 3a₃ is similar to the switch circuit 3a₂ while the switch 3a₃ further includes a first lighting device 60 in a serial connection with a current-limiting resistor R_{CL1} and a diode D₁. In one implementation, the first lighting device 60 is a light emitting diode (LED). In FIG. 4D, the first lighting device 60 could be a neon light coupled with another current-limiting resistor R_{CL2} as an indicating light for displaying the condition of the switch unit 27. For example, if the switch unit 27 is turned off (i.e., the input terminal Lin is disconnected from the output terminal Lout), the first lighting device 60 emits no light. If the switch unit 27 is turned on (i.e., the input terminal Lin is connected with the output terminal Lout), the first lighting device 60 emits the light.

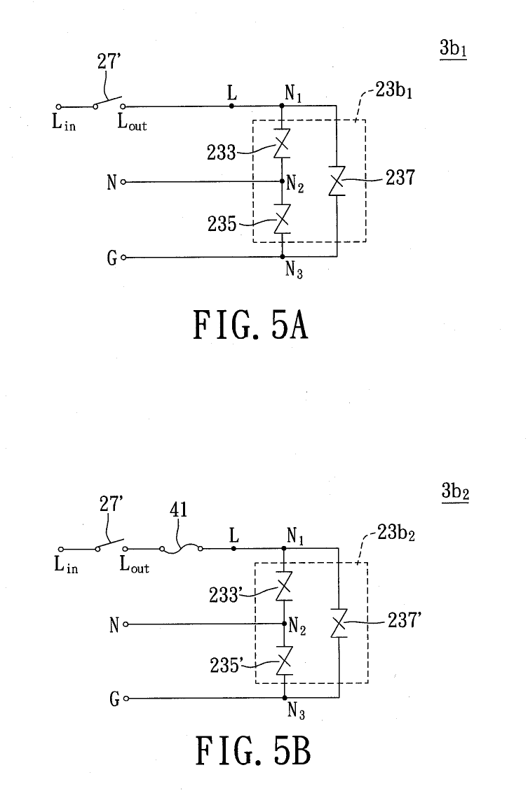

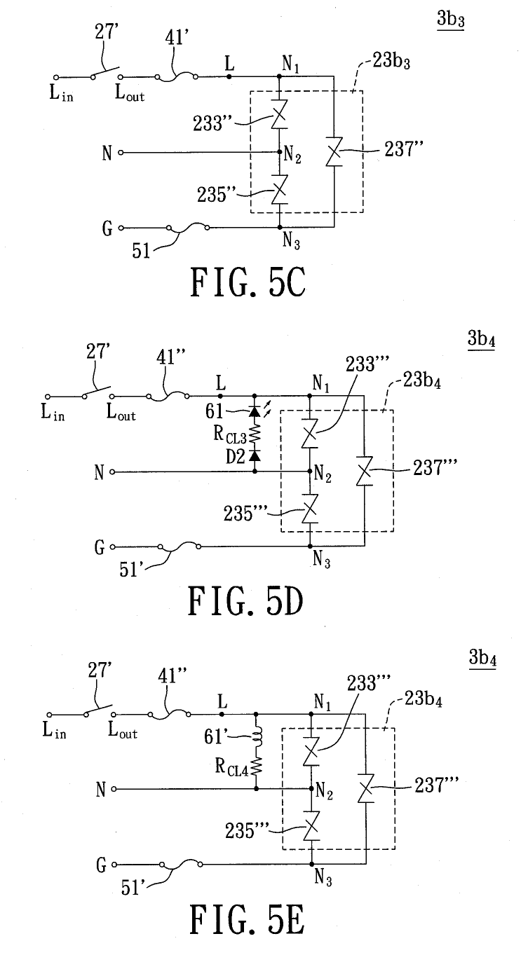

FIG. 5A is a circuitry diagram of the switch module in accordance with one embodiment of the present invention.

A switch module 3b₁ includes a surge absorber 23b₁, an input terminal Lᵢₙ, an output terminal Lₒᵤₜ, a switch unit 27′, a power source terminal L, an auxiliary terminal N, a ground terminal G, a first node N₁, a second node N₂ and a third node N₃. One end of the power source terminal L is coupled with the first node N₁, and the other end of the power source terminal L is coupled with the power source via the connection between the input terminal Lin and the output terminal Lₒᵤₜ. One end of the auxiliary terminal N is coupled with another power source of an opposite polarity, and the other end of the auxiliary terminal N is coupled with the second node N₂. One end of the ground terminal G is coupled with a ground, and the other end of the ground terminal G is coupled with the third node N₃.

The surge absorber 23b₁ includes a second surge absorption device 233, a third surge absorption device 235 and the fourth surge absorption device 237. These surge absorption devices 233, 235 and 237 are coupled with one another in a serial or a parallel connection. In one implementation, the second surge absorption device 233 is disposed between the first node N₁ and the second node N₂, the third absorption device 235 is disposed between the second node N₂ and the third node N₃, and the fourth surge absorption device 237 is disposed between the first node N₁ and the third node N₃. The three surge absorption devices 233, 235, and 237 collectively may form a three-phase current diverter. An electronic device (not shown) is disposed between the first node N₁ and the third node N₃. When the surge absorber 23b1 receives a voltage spike from the power source terminal L, the auxiliary terminal N or the ground terminal G, these surge absorption devices 233, 235 and 237 are shorted to allow the current to pass through these surge absorption devices 233, 235 and 237 rather than the connected electronic device. Since the voltage spike is received by the surge absorption devices 233, 235, and 237, the electronic device may be isolated from the voltage spike while the heat associated therewith may dissipate.

FIG. 5B is a circuitry diagram of the switch module in accordance with one embodiment of the present invention.

A switch circuit 3b₂ is similar to the switch circuit 3b₁ while the switch circuit 3b₂ further includes a surge absorber 23b₂ having a second thermal protection device 41 coupled with the power source terminal L and the output terminal Lₒᵤₜ. In one implementation, the second thermal protection device 41 is a fuse. The second surge absorption device 233′ may absorb the voltage spike of a short duration and the transient voltage spike. If the voltage spike received by the second surge absorption device 233′ reaches or exceeds a predetermined threshold or the received voltage spike lasts for too long the received voltage spike may be turned to the heat, which may damage components around the second surge absorption device 233′ or even cause the switch module 2a, 2b or 2c to burn. Therefore, absent the voltage spike the second thermal protection device 41 is conducted with a very little impedance. On the other hand, when any voltage spike has been received and causes the temperature at the second thermal protection device 41 to reach or exceed a predetermined threshold temperature the second thermal protection device 41 is open circuited to stop the current from passing through the second surge absorption device 233′ so as to protect the surge absorber 23b₂ and the components around.

FIG. 5C is a circuitry diagram of the switch module in accordance with one embodiment of the present invention.

A switch circuit 3b3 is similar to the switch circuit 3b₂ while the switch circuit 3b₃ further includes a surge absorber 23b₃ having a third thermal protection device 51 coupled with the third node N₃ and the ground terminal G when the second thermal protection device 41′ is unable to remain open-circuited, the third thermal protection device 51 may be open circuited to stop the current from entering into the surge absorber 23b₃ so as to protect the surge absorber 23b₃ and the components around.

FIG. 5D and FIG. 5E are circuitry diagrams of the switch module in accordance with one embodiment of the present invention.

A switch circuit 3b₄ is similar to the switch circuit 3b3 while the switch circuit 3b₄ further includes the surge absorber 23b₄ having a second lighting device 61 coupled to a current-limiting resistor R_{CL3} and another diode D₂ in a serial connection. In one implementation, the second lighting device 61 could be a light emitting diode (LED). The second lighting device 61 could be a neon light coupled with another current-limiting resistor R_{CL4} for displaying the condition of the switch unit 27′. For example, if the switch unit 27′ is turned off (i.e., the input terminal Lin is disconnected from the output terminal Lout), the second lighting device 61 emits no light. If the switch unit 27′ is turned on (i.e., the input terminal Lin is connected with the output terminal Lout), the second lighting device 61 emits the light.

To sum up, the present invention utilizes the surge absorber connected to an input terminal and an output terminal of a power source so as to serve the dual purpose of power switching and absorbing the voltage spike. Besides, the present invention utilizes the thermal protection device to obtain a better protection in response to the voltage spike.

What are disclosed above are only the specification and the drawings of the preferred embodiment of the present invention and it is therefore not intended that the present invention be limited to the particular embodiment disclosed. It will be understood by those skilled in the art that various equivalent changes may be made depending on the specification and the drawings of the present invention without departing from the scope of the present invention.

What is claimed is:

1. A switch module, comprising:
a casing having an input terminal, an output terminal and an auxiliary terminal, wherein the input terminal is coupled with a power source;
a switch unit installed in the casing and between the input terminal and the output terminal for connecting or disconnecting the input terminal to the output terminal; and
a surge absorber installed in the casing and between the output terminal and the auxiliary terminal for absorbing a voltage spike from the power source when the input terminal connects with the output terminal.

2. The switch module as claimed in claim 1, wherein the surge absorber comprises a first surge absorption device coupled with the input terminal and the auxiliary terminal.

3. The switch module as claimed in claim 2, wherein the casing further includes a ground terminal.

4. The switch module as claimed in claim 3, wherein the surge absorber further comprises a second surge absorption device coupled with the auxiliary and the ground terminal.

5. The switch module as claimed in claim 4, wherein the surge absorber further comprises a third surge absorption device coupled with the output terminal and the ground terminal.

6. The switch module as claimed in claim 1, further comprising a first thermal protection device coupled with the output terminal and the surge absorber.

7. The switch module as claimed in claim 6, further comprising a second thermal protection device which is coupled with the ground terminal and the surge absorber.

8. The switch module as claimed in claim 1, further comprising a lighting device coupled with the output terminal and the auxiliary terminal.

9. The switch module as claimed in claim 8, wherein the lighting device is a light emitting diode or a neon light.

10. The switch module as claimed in claim 1, further comprising a switch controller installed at one side of the casing and connected with the switch unit for controlling the switch unit to connect or disconnect the input terminal with the output terminal.

11. The switch module as claimed in claim 10, wherein the switch controller is a bimetal strip or a thermal sensing plate.
